(19) United States
(12) Patent Application Publication
(10) Pub. No.: US 2007/0052135 A1
(43) Pub. Date: Mar. 8, 2007

(54) Magnetic articulated sliding undercut mechanism

(76) Inventor: Hollis Habeger, Crete, IL (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/219,162

(22) Filed: Sep. 2, 2005

(51) Int. Cl. B29C 51/20

(52) U.S. Cl. 264/318; 425/394

(57) ABSTRACT

The present invention relates to a magnetic articulated sliding undercut mechanism for use with an apparatus for forming a plastic article from a sheet of plastic material heated to a predetermined forming temperature. The magnets are situated below the sliding undercut and, along with the stripper plate mechanism, help return the sliding undercut mechanism to its starting position after the thermoforming process has been completed. The use of the magnets also allows the sliding undercut mechanism to set itself in the same position every time it returns back to its molding or relaxed position.

### FIELD OF THE INVENTION

The present invention relates generally to an apparatus and method for thermoforming plastic articles having heavy undercuts, and in particular, to a magnetic articulated sliding undercut mechanism designed to form the undercut portions.

### BACKGROUND OF THE INVENTION

While thermoforming plastic articles from a heated sheet of plastic material may have production advantages over molding articles by the so-called injection molding process, one advantage of utilizing the injection molding process has been the ability to produce plastic articles in relatively complex shapes. For example, with injection molding, it is possible to produce relatively deep undercuts in various portions of a molded article. However, one of the practical limitations of the injection molding process relates to the minimum wall thickness which can be obtained in the molded article. The production of relatively thin walled articles by injection molding is difficult, if not impossible, to achieve. Also, the production rate of an injection molded process is far less than that of a thermoforming process.

By utilizing a thermoforming process, it is feasible to produce plastic articles such as containers, lids, and other plastic articles having relatively thin walls. As compared to an injection molding process, a thermoforming process has the advantage of relatively high speed production and considerably more economical tooling costs. However, the thermoforming technique has had the disadvantage of not adapting itself to rapid molding of complex shapes and, in particular; it has been difficult to efficiently produce a thermoformed article having an undercut portion.

It has been possible to produce undercuts in a plastic article by the thermoforming process by the use of expanding collets or split mold assemblies. However, the use of expanding collets or split molds greatly increase the complexity and tooling cost of the machinery. More importantly, expanding collets and split molds greatly increase the length of the production cycle of the plastic article.

There have been several developments directed to producing an undercut portion in a thermoformed plastic article. One such development includes the use of cooled mold portions which impinge upon selected areas of a heated plastic sheet and rigidify the same so that the uncooled portions can be folded to form an undercut or reverse bend section. Such an approach is disclosed in more detail in U.S. Pat. No. 3,284,553.

Another approach to producing undercut portions in thermoformed plastic articles is disclosed in U.S. Pat. No. 3,337,664. This patent discloses the use of differential air pressure across selected portions of the heated plastic sheet to cause an undercut portion to be formed in the plastic article.

Still another approach to forming undercut portions in thermoformed plastic articles is disclosed in U.S. Pat. No. 3,126,582. In this patent, a sheet of plastic material is vacuum formed around a mold member carrying a piece of resilient material which projects beyond the edge of the adjacent mold section to form the undercut portion, and which flexes to facilitate stripping of the formed article from the mold without the need of having a movable mold member.

A more recent approach to forming undercut sections has been the use of air spring activated sliding or pivoting undercut sections that are part of a stripper plate assembly that defines a lower portion of a forming cavity. The sliding undercut sections move along an inclined surface with the stripper plate member so that the plastic article can be formed and removed. The stripper plate is usually actuated with air cylinders in strategic positions. When these cylinders are fired after the initial thermoforming process is complete, and the mold starts to open, they move the stripper plate in a downward movement, such that the pressurized air from the cylinders causes the air springs to extend and move the sliding undercut sections downwardly and outwardly to a retracted position. Once the part is finally free from the cavity and sliding undercut mechanism, the stripper plate cylinders will relax and allow the stripper plate to come back into the down position. The return of the stripper plate to the down position also forces the sliding undercut mechanism downwardly by compression of the air springs. However, the sliding undercut mechanism doesn't always return to its starting or relaxed position before the next forming process occurs. When this occurs, the next part will be deformed and unusable. Even more, this condition could cause damage to the mold components.

An apparatus for thermoforming plastic articles is needed wherein the sliding undercut mechanism is retracted to its starting or relaxed position by the use of means other than air springs. Such means would allow the sliding undercut mechanism to set itself in the same position every time the stripper plate started its way back to the relaxed position. Having the sliding undercut mechanism in its starting position before the next forming process occurred would ensure that all parts are formed correctly and that damage does not occur to partially retracted components.

### SUMMARY OF THE INVENTION

The present invention relates to a sliding undercut mechanism for use with an apparatus for forming a plastic article from a sheet of plastic material heated to a predetermined forming temperature. The apparatus comprises a first mold section having forming surfaces defining a forming cavity, a second mold section axially movable along a forming axis in one direction toward the first mold section for urging at least a portion of the heated plastic sheet into the forming cavity of the first mold section to form the plastic article and a first predetermined distance away from the first mold section along the forming axis in an opposite direction relative to both the forming cavity and the undercut forming element for removal of the formed plastic article from the forming cavity, and a stripper plate movable a second predetermined distance along the forming axis in the opposite direction for freeing the formed plastic article from the forming cavity by initially moving the formed plastic article the same predetermined distance in the opposite direction along the forming axis relative to the forming cavity.

The sliding undercut mechanism is located at an angle θ between the stripper plate and the first mold section and is pulled upwards from a forming position to a retracted position along the angle by the stripper plate when the stripper plate moves the second predetermined distance. The angle θ of the sliding undercut mechanism is between about 10° to about 30° relative to an axis that is perpendicular to the first mold section. The sliding undercut mechanism comprises undercut forming elements for forming an undercut portion in the plastic article when the second mold section urges the heated plastic sheet into the forming cavity of the first mold section. The apparatus further comprises magnets coupled to the bottom of the first mold section and located below the sliding lock mechanism. The magnets, along with the stripper plate mechanism, help move the sliding lock mechanism from the retracted position to the forming position after the plastic article is removed from the apparatus.

In operation, the second mold section is moved along a forming axis in one direction toward the first mold section for urging at least a portion of the heated plastic sheet into the forming cavity of the first mold section to form the plastic article while the undercut forming element is in the forming position. The second mold section moves the plastic article a first predetermined distance away from the first mold section along the forming axis in an opposite direction relative to both the forming cavity and the undercut forming element for removal of the formed plastic article from the forming cavity. The stripper plate is then moved a second predetermined distance along the forming axis in the opposite direction for freeing the formed plastic article from the forming cavity by initially moving the formed plastic article the same second predetermined distance in the opposite direction along the forming axis relative to the forming cavity. The stripper plate pulls the sliding undercut mechanism upwards from the forming position to a retracted position along the angle when the stripper plate moves the same second predetermined distance such that the stripper plate, sliding undercut mechanism, and plastic article are all simultaneously moved in an opposite direction along the forming axis for the first predetermined distance.

After removing the plastic article, the stripper plate and the sliding undercut mechanism are returned to the forming position. The use of magnets coupled to the bottom of the first mold section and located below the sliding lock mechanism, along with the stripper plate mechanism, help return the sliding undercut mechanism to its starting position.

### BRIEF DESCRIPTION OF THE DRAWINGS

FIG. 1 is an exploded perspective side view of the first mold section showing the forming cavity, sliding undercut mechanism, and magnets.

FIG. 2 is a cross sectional view of the thermoforming apparatus.

FIG. 3 is a cross sectional view of the first mold section, sliding undercut mechanism, stripper plate, and the formed, untrimmed thermoplastic part with scrap still intact.

FIG. 4 is a perspective view of the single formed thermoplastic part showing the undercut portions.

### DETAILED DESCRIPTION OF PREFERRED EMBODIMENTS

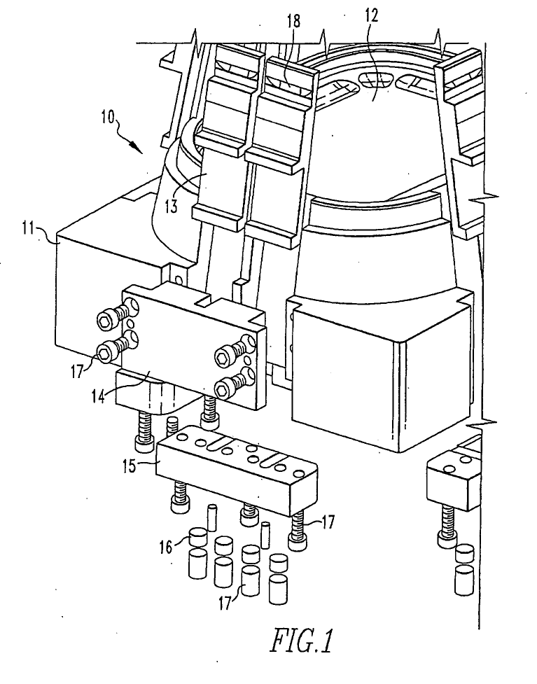

FIG. 1 is an exploded perspective side view of the first mold section 10. The first mold section 10 comprises the forming cavity 11 having a forming surface 12, the sliding undercut mechanisms 13, a side retainer 14 that is located in front of the sliding undercut mechanisms 13 and coupled to the forming cavity 11, and a bottom retainer 15 that is located underneath the sliding undercut mechanisms 13 and the side retainer 14, is coupled to the forming cavity 11, and has pockets 30 on its underside for the housing of magnets 16. The magnets 16 are inserted into the pockets 30 and have their undersides coupled to the bottom retainer 15. The forming cavity 11 and side and bottom retainers 14, 15 are of a metal material, preferably aluminum. The sliding undercut mechanisms 13 are preferably stainless steel, but could be comprised of another metal material. For the purposes of this invention, the magnets 16 used were rare earth magnets. However, other magnets, such as Alnico magnets, could also be used. The side and bottom retainers 14, 15 are coupled to the forming cavity 11 and the magnets 16 are coupled to the bottom retainer 15 via coupling means 17 such as clamps, screws, fasteners, or a nut and bolt combination. The coupling means 17 preferably are aluminum or steel material, however the coupling means 17 may be comprised of any metal, metal alloy, or nonmetal that would provide rigid structural support. The sliding undercut mechanisms 13 contain the undercut forming elements 18 required to form the undercut portions 29.

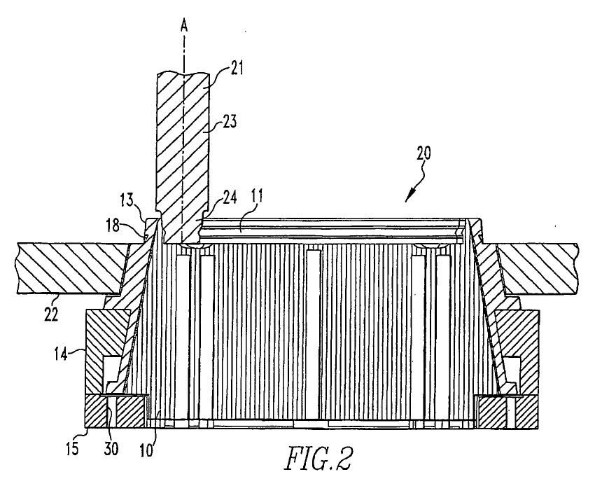

FIG. 2 is a cross sectional view of the thermoforming apparatus 20. In addition to the elements of the first mold section 10, as shown in FIG. 1, FIG. 2 includes the second mold section 21 and the stripper plate mechanism 22. The first and second mold sections 10, 21 are shown in an advanced or forming position. The second mold section 21 is moved along a forming axis, designated in FIG. 2 as A, in one direction toward the first mold section 10 for urging at least a portion of the heated plastic sheet 26 into the forming cavity 11 of the first mold section 10 to form the plastic article 25 while the undercut forming element 18 is in the forming position. The heated sheet 26 of thermoplastic material may be polyethylene, polystyrene, or other well known thermoplastic materials. The thermoplastic material is initially extruded into sheet form and is then fed into a heating station (not shown) where it is heated to the desired forming temperature. From the heating station, the heated sheet 26 is fed into the thermoforming apparatus 20 such that, as shown in FIG. 3, the sheet 26 is positioned between the first and second mold sections 10, 21. While not shown in the drawings, conventional means are provided for moving the first mold section 10 and the second mold section 21 toward and away from one another along an axial path designated in FIG. 2 as forming axis A.

The second mold section 21, which is made from metal, preferably aluminum, includes a main body portion 23 having a downwardly extending assist plug 24 securely attached thereto. The assist plug is utilized to initially force a portion of the sheet 26 of the thermoplastic material downwardly into the forming cavity 11 of the first mold section 10. At this time, a vacuum source (not shown) can be applied to various spaced apart vacuum ports that are present in the first mold section 10 and open into the upper portion of the forming cavity 11. The vacuum is applied to the ports to ensure that the heated plastic is in intimate contact with the side wall of the forming cavity 11. In addition, the heated plastic is also brought into contact with the forming cavity 11 by the simultaneous application of pressurized air through the second mold section 21. The pressurized air is introduced into the second mold section 21 under the assist plug 24. The second mold section 21 is encased in an airtight box commonly referred to as the plug base.

The stripper plate mechanism 22, which is comprised of metal, preferably aluminum, is mounted for selective vertical movement toward and away from the first mold section 10. The stripper plate 22 works with the sliding undercut mechanism 12 to pull the formed plastic article 25 from the forming cavity 11. While not shown in the drawings, conventional means, such as air cylinders, are provided for controlling the vertical movement of the stripper plate mechanism 22.

FIG. 3 is a cross sectional view of the forming cavity 11, sliding undercut mechanism 13, stripper plate mechanism 22, and the formed, untrimmed thermoplastic part 25 with scrap 26 still intact. After the part 25 is formed, the second mold section 21 moves a first predetermined distance away from the first mold section 10 along the forming axis in an opposite direction relative to both the forming cavity 11 and the undercut forming elements 18 for removal of the formed plastic article 25 from the forming cavity 11. Removal of the article 25 begins by firing the stripper plate air cylinders and having the stripper plate mechanism 22 gradually pull the sliding undercut mechanism 13 upwards along a given angle a second predetermined distance in the same direction as the second mold section 21. As the stripper plate 22 moves upwards, the undercut mechanism 13 is moving in both the upwards direction and sideways. The amount of stripper movement, along with the degree of total undercut for any particular design, aids in determining the angle that the undercut mechanism 13 must be positioned. For the purposes of this invention, the angle θ is between about 10 degrees and about 30 degrees relative to an axis B that is perpendicular to the first mold section 10. The depth of the undercut 18 is also shown more clearly in FIG. 3. The undercut 18 can be of any depth, but for the purposes of this invention the depth ranges from between about one-eighth inch to about three-sixteenth inch.

When the part 25 is finally free from the forming cavity 11 and sliding undercut mechanism 13, the stripper plate air cylinders will relax and allow the stripper plate mechanism 22 to return to the relaxed or starting position. While the stipper plate mechanism 22 is returning to the relaxed position, the sliding undercut mechanism 13 will also start to move back down to the rest or relaxed position. When the stripper plate mechanism 22 returns to the full down rest or relaxed position, the magnets 16 will further pull the sliding undercut mechanism 13 back to its starting or relaxed position. The usage of the magnets 16 also allows the sliding undercut mechanism 13 to set itself in the same position every time the stripper plate mechanism 22 starts its way back to the molding or relaxed position. The untrimmed thermoplastic part 25 can be transferred to a cutting station where the individual plastic article 25 can be cut from the plastic sheet 26.

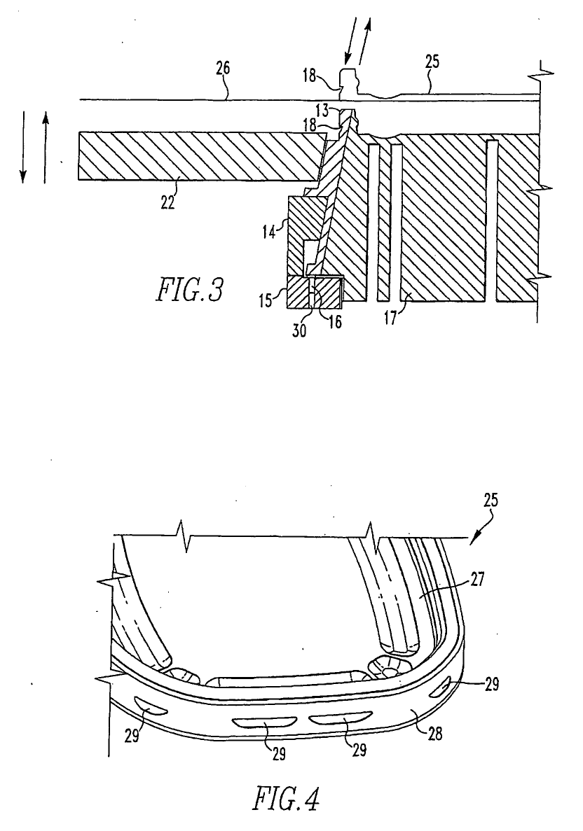

FIG. 4 is a perspective view of the single formed thermoplastic part 25. The part 25 includes a generally rectangular base 27 surrounded by tapered walls 28 extending downwardly and slightly outwardly from the base 27. The walls 28 are provided with undercut portions 29.

While the apparatus 20 illustrated in the drawings is specifically designed to form the undercut portion 29 in the article 25, it will be appreciated that the apparatus 20 could readily be adapted to form other types of articles having different undercut configurations. For example, the article 25 could be of a cylindrical design and/or the undercut portion could be located at a different location along the wall 28 of the article 25. Further, as will be appreciated, means can be provided for forming a single or a plurality of undercut portions 29 along the sidewall 28 of the plastic article 25. Also, while the drawings illustrate one portion of the forming apparatus utilized for producing a single plastic article, the forming apparatus 20 can include a plurality of singular forming mechanisms for simultaneously forming a plurality of plastic articles.

Having described the presently preferred embodiments, it is to be understood that the invention may be otherwise embodied within the scope of the appended claims.

What is claimed is:

1. A sliding undercut mechanism for use with an apparatus for forming a plastic article from a sheet of plastic material heated to a predetermined forming temperature, said apparatus comprising a first mold section having forming surfaces defining a forming cavity, a second mold section axially movable along a forming axis in one direction toward the first mold section for urging at least a portion of the heated plastic sheet into said forming cavity of said first mold section to form said plastic article, said second mold section movable in an opposite direction away from said first mold section a first predetermined distance along the forming axis relative to the forming cavity for removal of the formed plastic article from the cavity; a stripper plate movable a second predetermined distance along said forming axis in said opposite direction for freeing the formed plastic article from said forming cavity by initially moving said formed plastic article said second predetermined distance in said opposite direction along said forming axis relative to said forming cavity, said sliding undercut mechanism comprising:
undercut forming elements for forming an undercut portion in said plastic article when said second mold section urges said heated plastic sheet into said forming cavity of said first mold section,
wherein said sliding undercut mechanism is located at an angle θ between said stripper plate and said first mold section and pulled upwards from a forming position to a retracted position along said angle by said stripper plate when said stripper plate moves said second predetermined distance, said sliding undercut mechanism returning from said retracted position to a forming position via the use of magnets, said magnets coupled to the bottom of said first mold section and located below said sliding lock mechanism.

2. The sliding undercut mechanism of claim 1 wherein said angle θ of said sliding undercut mechanism is between about 10 degrees to about 30 degrees relative to an axis traveling through said first mold section, said axis being perpendicular to said first mold section.

3. The sliding undercut mechanism of claim 1 wherein said undercut forming elements comprise a depth of between about one-eighth inch and about three-sixteenth inch.

4. An apparatus for forming a plastic article from a sheet of plastic material heated to a predetermined forming temperature, said apparatus comprising:
a first mold section having forming surfaces defining a forming cavity,
a second mold section axially movable along a forming axis in one direction toward said first mold section for urging at least a portion of the heated plastic sheet into said forming cavity of said first mold section to form said plastic article, said second mold section movable in an opposite direction away from said first mold section a first predetermined distance along the forming axis relative to the forming cavity for removal of the formed plastic article from the cavity;
a stripper plate movable a second predetermined distance along said forming axis in said opposite direction for freeing the formed plastic article from said forming cavity by initially moving said formed plastic article said second predetermined distance in said opposite direction along said forming axis relative to said forming cavity; and
a sliding undercut mechanism located at an angle θ between said stripper plate and said first mold section and pulled upwards from a forming position to a retracted position along said angle by said stripper plate when said stripper plate moves said second predetermined distance, said sliding undercut mechanism including undercut forming elements for forming undercut portions in said plastic article when said second mold section urges said heated plastic sheet into said forming cavity of said first mold section, said sliding undercut mechanism returning from said retracted position to a forming position via the use of magnets, said magnets coupled to the bottom of said first mold section and located below said sliding undercut mechanism.

5. The apparatus of claim 4 wherein said angle θ of said sliding undercut mechanism is between about 10 degrees to about 30 degrees relative to an axis traveling through said first mold section, said axis being perpendicular to said first mold section.

6. The apparatus of claim 4 wherein said undercut forming elements comprise a depth of between about one-eighth inch and about three-sixteenth inch.

7. A method of forming a plastic article from a sheet of plastic material heated to a predetermined forming temperature, comprising:
an apparatus including a first mold section having forming surfaces defining a forming cavity, a second mold section located opposite said first mold section, a stripper plate located peripherally to said first mold section, and a sliding undercut mechanism located at an angle θ between said stripper plate and said first mold section, said sliding undercut mechanism including undercut forming elements for forming undercut portions in said plastic article when said sliding undercut mechanism is in a forming position;
moving said second mold section along a forming axis in one direction toward said first mold section for urging at least a portion of said heated plastic sheet into said forming cavity of said first mold section to form said plastic article while said undercut forming element is in said forming position;
moving said second mold section a first predetermined distance away from said first mold section along said forming axis in an opposite direction relative to both said forming cavity and said undercut forming element for removal of said formed plastic article from said forming cavity;
moving said stripper plate a second predetermined distance along said forming axis in said opposite direction for freeing the formed plastic article from said forming cavity by initially moving said formed plastic article said second predetermined distance in said opposite direction along said forming axis relative to said forming cavity, said stripper plate pulling said sliding undercut mechanism upwards from said forming position to a retracted position along said angle when said stripper plate moves said second predetermined distance such that said stripper plate, said sliding undercut mechanism, and said plastic article are all simultaneously moved in said opposite direction along said forming axis for said second predetermined distance;
removal of said plastic article from said sliding undercut mechanism and said stripper plate; and
returning said stripper plate and said sliding undercut mechanism to said forming position, said sliding undercut mechanism returning to said forming position via the use of magnets, said magnets coupled to the bottom of said first mold section and located below said sliding lock mechanism.

8. The method of claim 7 wherein said angle θθ of said sliding undercut mechanism is between about 10 degrees to about 30 degrees relative to an axis traveling through said first mold section, said axis being perpendicular to said first mold section.

9. The method of claim 7 wherein said undercut forming elements comprise a depth of between about one-eighth inch and about three-sixteenth inch.
